(19) United States
(12) Patent Application Publication
(10) Pub. No.: US 2026/0118319 A1
(43) Pub. Date: Apr. 30, 2026

(54) SENSING DEVICE

(71) Applicant: TXC Corporation, Taipei City (TW)

(72) Inventors: Bing-Jyun Guo, Taipei City (TW); Chih-Hung Chiu, Taipei City (TW); Yu Wen Feng, Taipei City (TW)

(73) Assignee: TXC Corporation, Taipei City (TW)

(21) Appl. No.: 18/945,432

(22) Filed: Nov. 12, 2024

(30) Foreign Application Priority Data
Oct. 30, 2024 (TW) 113211852

(51) Int. Cl. G01N 29/02

(52) U.S. Cl. CPC G01N 29/022; G01N 2291/0256; G01N 2291/0426

(57) ABSTRACT

A sensing device includes a quartz substrate, a first electrode, and a second electrode. The first electrode and the second electrode are respectively disposed on two opposite surfaces of the quartz substrate. The first electrode includes a first gold metal layer, a first chromium metal layer, and a first chromium oxide layer. The first gold metal layer is disposed on a surface of the quartz substrate. The first chromium metal layer is disposed between the first gold metal layer and the quartz substrate. The first chromium oxide layer is disposed between the first chromium metal layer and the first gold metal layer. A thickness of the first chromium oxide layer is greater than or equal to 1 nanometer and less than or equal to 10 nanometers.

### CROSS-REFERENCE TO RELATED APPLICATION

This application claims the priority benefit of Taiwan application serial no. 113211852, filed on Oct. 30, 2024. The entirety of the above-mentioned patent application is hereby incorporated by reference herein and made a part of this specification.

### BACKGROUND

### Technical Field

The disclosure relates to an electronic device, and in particular to a sensing device.

### Description of Related Art

With the development of science and technology, there are higher requirements for gas detection technology in fields such as environmental monitoring, food safety, and medical testing. Gas as a representative substance may be used in various detection environments. At present, gas detection technologies are mostly based on laboratory instrument analysis methods, such as gas chromatography and ion mass spectrometer detection. The equipment required for the detection technologies has issues such as high price and complex operating procedures, and gas detection cannot be performed immediately. A quartz crystal microbalance (QCM) sensing system based on a QCM sensor may implement high-speed detection of samples at room temperature and has extremely high detection accuracy. The QCM sensor is sensitive to mass changes and converts micro-mass changes generated by odor molecules adsorbed on an electrode surface into frequency changes to reflect sample information.

However, the accuracy of the QCM sensor is easily affected by temperature, which increases the error of the QCM sensor in environments with high temperatures or severe temperature changes, affecting the detection sensitivity and the versatility of the QCM sensor.

### SUMMARY

The disclosure provides a sensing device that can reduce errors caused by temperature to the sensing device to ensure the sensitivity and the versatility of the sensing device.

An embodiment of the disclosure provides a sensing device, including a quartz substrate, a first electrode, and a second electrode. The first electrode and the second electrode are respectively disposed on a first surface and a second surface opposite to each other of the quartz substrate. The first electrode includes a first gold metal layer, a first chromium metal layer, and a first chromium oxide layer. The first gold metal layer is disposed on the first surface of the quartz substrate. The first chromium metal layer is disposed between the first gold metal layer and the quartz substrate. The first chromium oxide layer is disposed between the first chromium metal layer and the first gold metal layer. A thickness of the first chromium oxide layer is greater than or equal to 1 nanometer and less than or equal to 10 nanometers.

In an embodiment of the disclosure, the second electrode further includes a second gold metal layer, a second chromium metal layer, and a second chromium oxide layer. The second gold metal layer is disposed on the second surface of the quartz substrate. The second chromium metal layer is disposed between the second gold metal layer and the quartz substrate. The second chromium oxide layer is disposed between the second chromium metal layer and the second gold metal layer.

In an embodiment of the disclosure, a thickness of the second chromium oxide layer is greater than or equal to 1 nanometer and less than or equal to 10 nanometers.

In an embodiment of the disclosure, the sensing device further includes a first adsorption layer disposed on the first electrode.

In an embodiment of the disclosure, the sensing device further includes a second adsorption layer disposed on the second electrode.

In an embodiment of the disclosure, the sensing device further includes an alternating power supply electrically connected to the first electrode and the second electrode.

In an embodiment of the disclosure, a material of the first adsorption layer includes a nanofiber thin film.

In an embodiment of the disclosure, the first adsorption layer includes a gel material.

Based on the above, the electrode of the sensing device of the disclosure includes the gold metal layer and the chromium metal layer, and the chromium oxide layer is disposed between the gold metal layer and the chromium metal layer. Stress of the electrode and the quartz substrate is affected by temperature changes and is one of the sources of measurement errors of the sensing device. The stress source is caused by chromium in a base layer of the electrode diffusing to the gold metal layer during a high-temperature process such that the electrode becomes a chromium-gold-chromium dual heterogeneous interface. The chromium oxide layer with an appropriate thickness may prevent chromium metal atoms from diffusing to the gold metal layer during the process, so that the stress of the sensing device may be reduced, thereby reducing noise generated by stress on the sensing device. In addition, by controlling the thickness of the chromium oxide layer, the sensing device may also be ensured to maintain the accuracy, effectively reducing errors of the sensing device and improving the versatility.

In order for the features and advantages of the disclosure to be more comprehensible, the following specific embodiments are described in detail in conjunction with the drawings.

### BRIEF DESCRIPTION OF THE DRAWINGS

FIG. 1A is a schematic structural diagram of a sensing device according to an embodiment of the disclosure, FIG. 1B is a schematic diagram of an oscillation wave pattern of the sensing device of FIG. 1A, FIG. 1C is a schematic diagram of the sensing device of the embodiment of FIG. 1A adsorbing particles, and FIG. 1D is a schematic diagram of an oscillation wave pattern of the sensing device of FIG. 1C.

FIG. 2 is a graph of a relationship between temperature and frequency deviation value of a QCM detector.

FIG. 3 is a schematic partial structural diagram of a sensing device according to an embodiment of the disclosure.

### DESCRIPTION OF THE EMBODIMENTS

The aforementioned and other technical contents, characteristics, and effects of the disclosure will be clearly presented in the following detailed description of a preferred embodiment with reference to the drawings. Directional terms, such as upper, lower, left, right, front, or rear, mentioned in the following embodiments are only directions with reference to the drawings. Therefore, the used directional terms are used to illustrate but not to limit the disclosure.

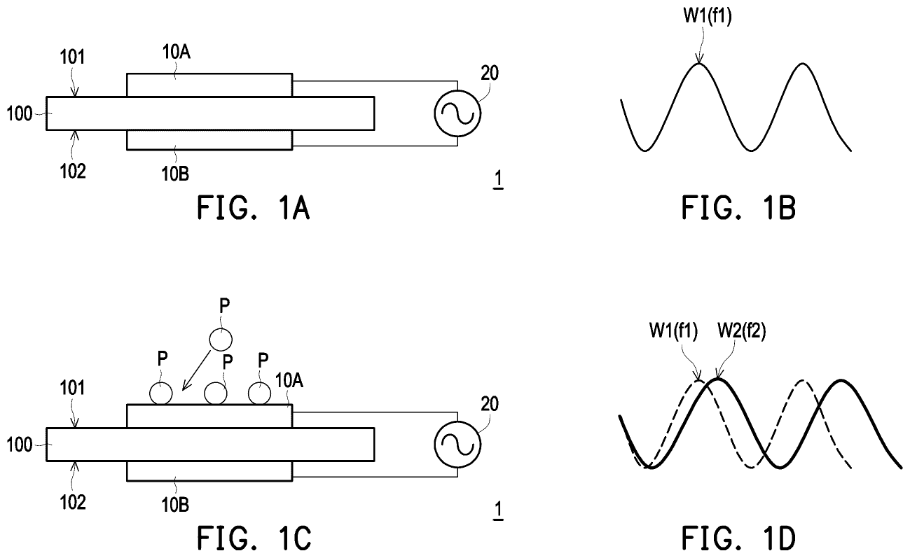

FIG. 1A is a schematic structural diagram of a sensing device according to an embodiment of the disclosure, and FIG. 1B is a schematic diagram of an oscillation wave pattern of the sensing device of FIG. 1A. Please refer to FIG. 1A and FIG. 1B. A sensing device 1 includes a quartz substrate 100, a first electrode 10A, and a second electrode 10B. The quartz substrate 100 has a first surface 101 and a second surface 102 disposed opposite to each other. The first electrode 10A and the second electrode 10B may be respectively disposed on the first surface 101 and the second surface 102. The outlines (for example, projections in a direction Z) of the first electrode 10A and the second electrode 10B on a projection plane of the quartz substrate 100 may be square outlines, circular outlines, or outlines with other shapes, but the disclosure is not limited thereto. The sensing device 1 may be configured to perform composition analysis of gas or liquid and measurement of micro-mass. Therefore, the sensing device 1 may be applied to different detection systems, such as being applied to the chemical detection field or fields such as electronics, physics, biology, medicine, and surface science, but the disclosure is not limited thereto.

Specifically, the sensing device 1 includes a quartz crystal microbalance (QCM) sensor. The principle of the QCM sensor is to utilize the inverse piezoelectric effect of a quartz crystal. If an alternating electric field is applied to two electrodes of the quartz crystal, the quartz crystal will generate mechanical vibration. When the oscillation frequency of the quartz crystal is close to or substantially consistent with the vibration frequency of the alternating electric field, the amplitude of the quartz crystal may reach the maximum and present a stable resonance phenomenon. Utilizing such characteristic, the resonance frequency may be measured after electrically connecting the quartz crystal to a circuit. For example, in FIG. 1A, the sensing device 1 may include an alternating power supply 20 electrically connected to the first electrode 10A and the second electrode 10B, so that when the alternating power supply 20 is enabled, the sensing device 1 may generate a first wave pattern W1 with a first frequency f1, as shown in FIG. 1B.

Please refer to FIG. 1C next. When the sensing device 1 adsorbs an object to be measured, for example, when the sensing device 1 adsorbs particles P, the total mass of the sensing device 1 changes, so the resonance frequency of the sensing device 1 also changes. Taking FIG. 1D as an example, when the alternating power supply 20 enables the sensing device 1 adsorbing the particles P, the sensing device 1 may generate a second wave pattern W2 with a second frequency f2. By analyzing the change in the first frequency f1 and the second frequency f2, the total mass of the particles P adsorbed by the sensing device 1 may be measured, so that the concentration value of the particles P in an environment may be deduced to achieve the objective of concentration detection.

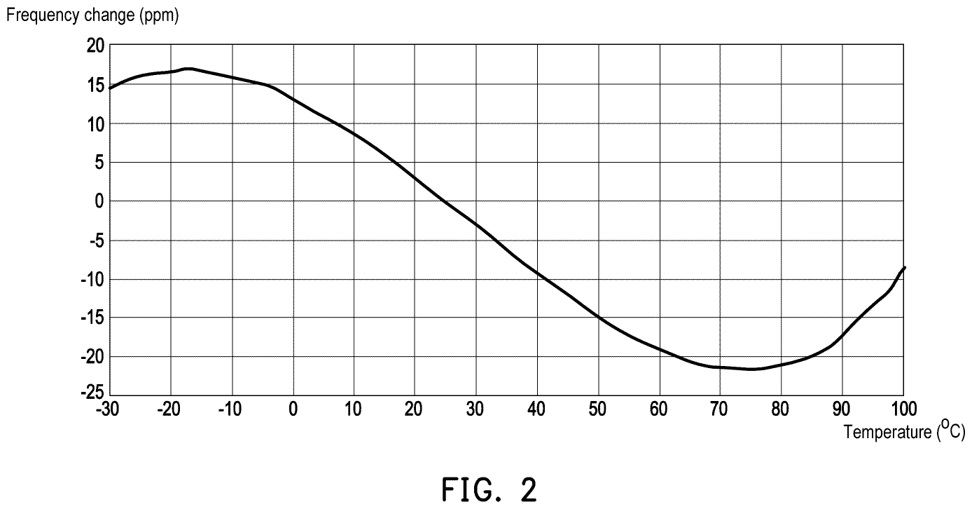

FIG. 2 is a graph of a relationship between temperature and frequency deviation value of a QCM detector. The QCM sensor needs to be kept in a constant temperature environment during measurement because the material characteristics of the quartz crystal causes the vibration frequency thereof to change with temperature, and the stress of the electrode changes with temperature. The quartz crystal and the electrode both affect a frequency result measured by the QCM sensor, causing measurement errors. Taking FIG. 2 as an example, the frequency deviation value of the QCM sensor is about 5 (ppm) when the temperature is 15 degrees (Celsius), and the frequency deviation value becomes about −15 (ppm) when the temperature is 50 degrees (Celsius). Therefore, how to reduce frequency errors caused by temperature on the QCM sensor is an important topic in QCM sensor technology.

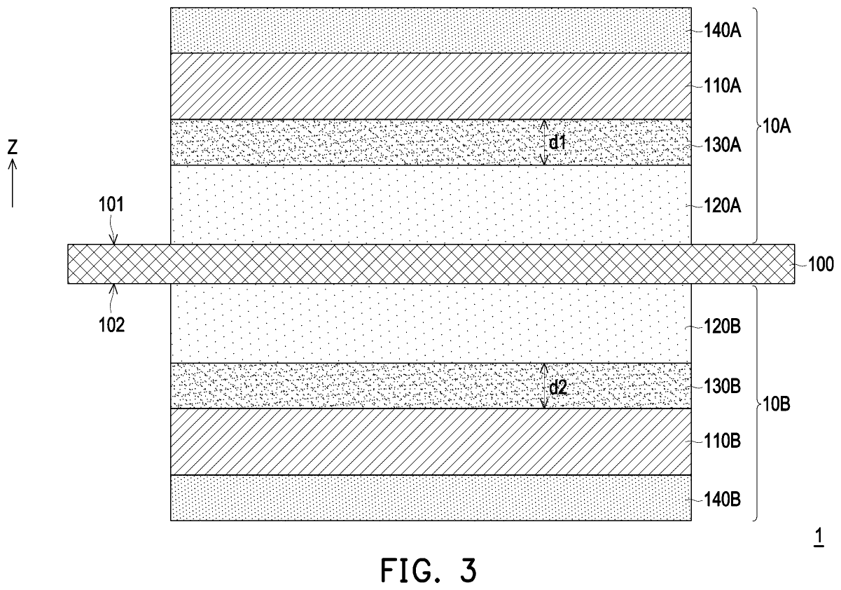

FIG. 3 is a schematic partial structural diagram of a sensing device according to an embodiment of the disclosure. Please refer to FIG. 3. The first electrode 10A may include a first gold metal layer 110A, a first chromium metal layer 120A, and a first chromium oxide layer 130A. The first gold metal layer 110A is disposed on the first surface 101. The first chromium metal layer 120A is disposed between the first gold metal layer 110A and the quartz substrate 100.

In some embodiments, the first chromium metal layer 120A may directly contact the first surface 101. The first chromium oxide layer 130A is disposed between the first chromium metal layer 120A and the first gold metal layer 110A. From another perspective, the first chromium metal layer 120A, the first chromium oxide layer 130A, and the first gold metal layer 110A of the first electrode 10A may be formed by sequentially stacking on the first surface 101 in the direction Z.

The preparation methods of the first chromium metal layer 120A, the first chromium oxide layer 130A, and the first gold metal layer 110A may be to form by sequentially depositing on the first surface 101 using physical vapor deposition (PVD), chemical vapor deposition (CVD), or atomic layer deposition (ALD), but the disclosure is not limited thereto.

In the sensing device 1, the relationship of frequency changes of a sensing chip composed of the quartz substrate 100, the first electrode 10A, and the second electrode 10B may satisfy the following conditional expression:

$$Δ f = \frac{- 2 {f}_{0}^{2}}{A \sqrt{ρμ}} \times Δ m + {f}_{A} ( T ) + {f}_{B} ( T )$$

where Δf is the frequency change sensed by the sensing device 1; A is the surface area of a thin film for adsorbing a substance on the first electrode 10A; ρ is the density of the quartz substrate 100; μ is the shear elastic modulus (g/(cm*s²)) of the quartz substrate 100; Δm is the mass of the adsorbed substance; f0 is the basic frequency of the sensing chip; fA is the frequency noise caused by stress; fB is the frequency noise caused by temperature on the quartz substrate 100. fA and fB are both functions of temperature and are noise sources of the frequency changes sensed by the sensing device 1. fB may be compensated and corrected via an empirical formula of temperature compensation. However, fA is affected by stress and is unpredictable and difficult to correct.

As mentioned above, the sensing accuracy of the sensing device 1 is proportional to the square of the basic frequency f0 of the sensing chip, but with a higher frequency, the thickness of the sensing chip needs to be reduced correspondingly. However, a lower thickness makes the sensing chip more easily affected by stress changes of the electrode. Therefore, in the first electrode 10A of the disclosure, the first chromium oxide layer 130A (for example, with a composition of CrO) is disposed between the first gold metal layer 110A and the first chromium metal layer 120A. The stress of the first electrode 10A and the quartz substrate 100 is affected by temperature changes and is one of the sources of the function fA. The stress source is caused by the first chromium metal layer 120A diffusing to the first gold metal layer 110A during a high-temperature process such that the first electrode 10A forms a chromium-gold-chromium dual heterogeneous interface. The setting of the first chromium oxide layer 130A may prevent atoms of the first chromium metal layer 120A from diffusing to the first gold metal layer 110A during the process, which may effectively reduce the stress of the sensing device 1, thereby reducing the noise generated by the stress on the sensing device 1.

In addition, by controlling a thickness d1 of the first chromium oxide layer 130A to be greater than or equal to 1 nanometer and less than or equal to 10 nanometers, the influence of stress due to temperature changes is reduced, so that the accuracy of the sensing device 1 is improved while ensuring that the thickness of the first electrode 10A is not too thick to maintain the sensitivity of the sensing device 1.

On the other hand, in the embodiment, the second electrode 10B may also include a second gold metal layer 110B, a second chromium metal layer 120B, and a second chromium oxide layer 130B. The second gold metal layer 110B is disposed on the second surface 102. The second chromium metal layer 120B is disposed between the second gold metal layer 110B and the quartz substrate 100. In some embodiments, the second chromium metal layer 120B may directly contact the second surface 102. The second chromium oxide layer 130B is disposed between the second chromium metal layer 120B and the second gold metal layer 110B. Reference may be made to the preparation methods of the first gold metal layer 110A, the first chromium metal layer 120A, and the first chromium oxide layer 130A for the preparation methods of the second gold metal layer 110B, the second chromium metal layer 120B, and the second chromium oxide layer 130B, which will not be described again here. From another perspective, the second electrode 10B and the first electrode 10A may be mirrored relative to the quartz substrate 100, but the disclosure is not limited thereto. In other embodiments, the second electrode 10B of the sensing device may be only a stacked structure of the second gold metal layer 110B and the second chromium metal layer 120B or a stacked structure of other metals or alloys. In some embodiments, a thickness d2 of the second chromium oxide layer 130B may also be greater than or equal to 1 nanometer and less than or equal to 10 nanometers.

In addition, in order to adsorb particles (for example, the particles P in FIG. 1C) of a sensed substance, the sensing device 1 may also include a corresponding adsorption layer. For example, the sensing device 1 may have a first adsorption layer 140A disposed on a surface of the first electrode 10A away from the quartz substrate 100. Similarly, the sensing device 1 may have a second adsorption layer 140B disposed on a surface of the second electrode 10B away from the quartz substrate 100. The materials of the first adsorption layer 140A and the second adsorption layer 140B may include nanofiber thin films or gel materials, but the disclosure is not limited thereto. In other embodiments, the sensing device may also have only one of the first adsorption layer 140A and the second adsorption layer 140B (that is, single-sided detection), but the disclosure is not limited thereto.

In summary, the electrode of the sensing device of the disclosure includes the gold metal layer and the chromium metal layer, and the chromium oxide layer is disposed between the gold metal layer and the chromium metal layer. The stress of the electrode and the quartz substrate is affected by temperature changes and is one of the sources of measurement errors of the sensing device. The stress source is caused by chromium in a base layer of the electrode diffusing to the gold metal layer during the high-temperature process such that the electrode becomes the chromium-gold-chromium dual heterogeneous interface. The chromium oxide layer with an appropriate thickness may prevent chromium metal atoms from diffusing to the gold metal layer during the process, so that the stress of the sensing device may be reduced, thereby reducing the noise generated by the stress on the sensing device. In addition, by controlling the thickness of the chromium oxide layer, the sensing device may also be ensured to maintain the accuracy, effectively reducing errors of the sensing device and improving the versatility.

However, the above are only preferred embodiments of the disclosure and should not be used to limit the scope of the disclosure, that is, simple equivalent changes and modifications made based on the claims of the disclosure and the description of the disclosure are all still within the scope of the disclosure. In addition, any embodiment or claim of the disclosure does not need to achieve all objectives, advantages, or characteristics of the disclosure. In addition, the abstract section and the title are only used to assist in searching patent documents and are not intended to limit the scope of the disclosure. In addition, terms such as “first” and “second” mentioned in the specification or the claims are only used to name elements or distinguish different embodiments or scopes and are not used to limit the upper limit or the lower limit of the number of elements.

What is claimed is:

1. A sensing device, comprising:
a quartz substrate, having a first surface and a second surface opposite to each other; and
a first electrode and a second electrode, respectively disposed on the first surface and the second surface, wherein the first electrode comprises:
a first gold metal layer, disposed on the first surface of the quartz substrate;
a first chromium metal layer, disposed between the first gold metal layer and the quartz substrate; and
a first chromium oxide layer, disposed between the first chromium metal layer and the first gold metal layer, wherein a thickness of the first chromium oxide layer is greater than or equal to 1 nanometer and less than or equal to 10 nanometers.

2. The sensing device according to claim 1, wherein the second electrode further comprises:
a second gold metal layer, disposed on the second surface of the quartz substrate;
a second chromium metal layer, disposed between the second gold metal layer and the quartz substrate; and
a second chromium oxide layer, disposed between the second chromium metal layer and the second gold metal layer.

3. The sensing device according to claim 2, wherein a thickness of the second chromium oxide layer is greater than or equal to 1 nanometer and less than or equal to 10 nanometers.

4. The sensing device according to claim 1, further comprising a first adsorption layer disposed on the first electrode.

5. The sensing device according to claim 1, further comprising a second adsorption layer disposed on the second electrode.

6. The sensing device according to claim 3, wherein a material of the first adsorption layer comprises a nanofiber thin film.

7. The sensing device according to claim 3, wherein the first adsorption layer comprises a gel material.
